(19) United States
(12) Patent Application Publication
(10) Pub. No.: US 2022/0391535 A1
(43) Pub. Date: Dec. 8, 2022

(54) END USER PRIVACY PROTECTION SYSTEM AND METHOD THEREOF

(71) Applicant: Nisha Krishna SAJESH KUMAR, Kerala (IN)

(72) Inventor: Nisha Krishna SAJESH KUMAR, Kerala (IN)

(21) Appl. No.: 17/776,229

(22) PCT Filed: Aug. 19, 2020
(86) PCT No.: PCT/IN2020/000018

§ 371 Date: May 12, 2022

(30) Foreign Application Priority Data
Nov. 15, 2019 (IN) 201941046611

(51) Int. Cl. G06F 21/62

(52) U.S. Cl. CPC G06F 21/6245

(57) ABSTRACT

An end user privacy Protection system and method thereof is disclosed. Said system comprises of an Hardware Processing Unit (HPU) featuring a means to set the time duration to allow the application access to mobile phone hardware components, a comparator unit to read the remaining permitted time on a counter at any given time, wherein said comparator unit activates a driver unit to activate a set of electric/electronic switches or relays to disconnect said mobile phone hardware components when the permitted time duration set by the user expires. The system also features a means to bypass the access restriction at any moment. This security method is implementable to the all the computers, laptops, smart devices and wearable devices other than mobile phone irrespective of its operating system.

### FIELD OF THE INVENTION

The present invention, in general, relates to devices that could prevent capturing of personal data from mobile devices without user permission. Particularly, the present invention relates to a security method and its implementation through a Hardware Processing Unit adapted to be plugged to a mobile device, wherein the user can configure said device to regulate application' or software access to mobile phone hardware components such as camera, microphone, location services and storage for user decided duration.

### DESCRIPTION OF PRIOR ART

We are living in a digitally connected world wherein mobile phones, computers, and social media have become inevitable parts of our lives. However, the dependence on these tools has also created a situation wherein our own privacy is seriously compromised. To a good extent, we have little or no control over the kind of data that is being captured and shared by our mobile phones. Many incidents wherein private data has been stolen without the permission of the users has been reported from across the globe. For example, recording videos of individuals without obtaining their permission, receiving advertisements on different social media platforms based on normal conversations, which has not even been searched on the internet for that matter, tracking and storing of locations of the user secretly, stealing personal data surreptitiously etc. are few of such instances wherein personal data is compromised, at times with serious enough consequences.

Access to your smartphone camera or webcam in your PC can be achieved through code. When a software is installed in your mobile phone, it might request access privilege to your device's camera and in most cases, the unsuspecting user grants access to these devices. On the other hand, malwares or spywares won't seek explicit permission. But both the two types of applications can turn ON your device's camera without your knowledge and can share these recordings to their servers at its creator's interest.

Likewise, the microphone in the mobile and the computer can also be hacked using a standard app/software or using a malware/spyware. There are tools, like Nosey Smurf, wherein someone can turn on your microphone and listen to everything that's going around using said tool. Also there are claims that the conversations of individuals were recorded and targeted advertisements were shown based on the conversation.

The location of your mobile devices are also hacked without user knowledge. Some apps fetch your location details even if you'd turned off the location services option. Google has provided an option to avoid capturing of locations, for that you need to visit the “web & app activity” page of Google and disable the setting accordingly. Unfortunately, it is enabled by default and we need to turn it OFF separately.

Similarly, there are apps that accesses the contents of your mobile device's/PC hard disk and permanent memory unit without user permission.

In the prior art literature, US20160037345A1 teaches a means to provide controlling access to protected functionality of a host device using a wireless device, wherein said wireless device is a wearable device. In said publication, the access to an app is restricted to instances where a wearable device is present and a verified session is in progress. However, the prior art literature is silent on any methods to prevent access to hardware components in the host device such as camera, microphone, and storage. It is more of a watch kind of device primarily to ease the user experience when his phone is not easily accessible.

The US Pat No. 2013055347 titled ‘hardware access control for mobile applications’ detail a method 2010130178 teaches a method for enabling remote and anonymous control of mobile and portable multimedia devices for security, tracking and recovery. However, in said method, the control of handset resources is achieved using software means. It is also silent on access of said resources by applications installed in the handheld device or mobile phone.

US Pat No. 2013055347 teaches a method and apparatus for hardware interface access control for mobile applications. But said method is realized through a software implementation, digital certificates, app policy engine wherein a virtual interface to an application is provided through which the application is to access a particular hardware interface. The virtual interface is provided by a second application integrated in a kernel layer of an operating system of the mobile device.

From the foregoing, it becomes apparent that there is a need for an accessory device that is capable of selectively allow apps' access to various hardware components in a mobile phone.

The present invention details an end user privacy protection system and method thereof wherein the user could regulate app/software access to mobile phone hardware such as camera, microphone, and storage, as well as location services for user selected duration. By default, the access to said hardware components is denied. If any of the application or software installed in the mobile device needs to use any of these hardware components/services, the user must interact with the system and choose an approximate required time of connection, whereupon the device's hardware/services will be accessible to the apps based on the privileges granted to said app at the time of its installation.

### SUMMARY OF THE INVENTION

The present invention details an End User Privacy Protection System and a security method implemented with a Hardware Processing Unit (HPU) connected to a mobile phone, wherein it is configured to restrict app/software access to mobile phone hardware such as camera, microphone, and storage, as well as location services under normal conditions. If any application or software needs to use any of these hardware/services, he/she needs to trigger said device and choose an approximate required time of connection. Then the device's hardware/services will be accessible based on the privileges granted to that app at the time of its installation. The device hardware and location services will be accessible to the app only for said time.

It is another object of the invention to give a distinct buzzer notification before the set time expiry at 19 seconds and 09 seconds.

It is yet another object of the invention to provide the user an option to extend said time if required.

It is a further object of the invention to restrict apps from accessing mobile phone hardware without explicit user permission.

It is yet another object of the invention to give more control to the user in regulating apps/software access to device hardware.

It is a further object of the invention to reduce cybercrimes.

It is yet another object of the invention to propose a device that is adapted to be plugged into any mobile phone, PC, tablet or handheld.

Accordingly, the present invention proposes an end user privacy protection system that enables users to restrict application' access to mobile hardware components such as camera, microphone, and storage as well as location services, except for user decided duration, said system comprising of:
a hardware interface adapted to receive control connections from said mobile hardware components;
time setter unit configured to set time from zero to 10 minutes, wherein a counter is incremented on each incremental pulse generated by an enabler switch (S1) initiated by the user;
run down counter configured to be loaded from said counter, wherein said run down counter is activated by the switch (S1) press.
comparator unit configured to disable application's access to the camera, mic, GPS, storage as well as location services once the countdown on the run down counter reads 00.00 minutes;
electric/electronic switches or relays configured to connect and disconnect access to the respective mobile phone hardware components; and
driver circuit configured to operate said electric/electronic switches or relays, wherein said driver circuit is driven by the output of the comparator unit.

Also the present invention proposes a method to regulate application access to mobile phone hardware components such as camera, microphone, and storage, as well as location services, said method comprising of:
setting the time on the timer during when the application' access to said hardware components is allowed, by pressing the enabler switch (S1), wherein the associated counter is incremented on each incremental pulse generated by respective switch presses;
loading said time on the run down counter, wherein said run down counter is activated on the switch (S1) press;
checking the down counter by the comparator unit, wherein it maintains a first digital logic state when the counter is running;
activating the electric/electronic switches or relays to connect the mobile phone hardware controls by the driver circuit based on said first digital logic state;
generating a second digital logic state by the comparator unit when the countdown reaches a pre-determined number; and
deactivating the electric/electronic switches or relays to disconnect the respective mobile phone hardware controls by the driver circuit.

The other objectives, features, and advantages of the present invention will become more apparent from the ensuing detailed description of the invention, taken in conjunction with the accompanying drawings.

### BRIEF DESCRIPTION OF ACCOMPANYING FIGURES

FIG. 1 shows the Hardware Processing Unit (HPU) of the end user privacy protection system.

FIG. 2 depicts the schematic diagram of the security method for accessing device hardware components during application usage.

FIG. 3 illustrates the de-bouncer circuit.

FIG. 4(a) shows the 74193 counter IC usage as up or down counter with load inputs; FIG. 4(b) shows the naming convention used to explain the display digits as the MSB and LSB of second display, and LSB of minute display.

FIG. 5 depicts the circuit for generating the seconds' digits

FIG. 6 illustrates the circuit for generating the MSB and LSB of minute

FIG. 7 depicts the comparator circuit.

FIG. 8 shows the driver circuit.

FIG. 9 illustrates the Hardware Processing Unit (HPU) of the end user privacy protection system integrated to a mobile phone.

FIG. 10 shows the screenshot of the recorded voice.

FIG. 11 depicts the screenshot of camera access being restricted using the system.

FIG. 12 illustrates the system restricting GPS access.

FIG. 13 shows the file copy/access in conditions wherein the file copy and access is permitted and disallowed.

FIG. 14 depicts the access register showing the detailed log of all the access to the mic, camera, GPS service and storage.

### DETAILED DESCRIPTION OF INVENTION

The preferred embodiments of the present invention will now be explained with reference to the accompanying drawings. It should be understood however that the disclosed embodiments are merely exemplary of the invention, which may be embodied in various forms. The following description and drawings are not to be construed as limiting the invention and numerous specific details are described to provide a thorough understanding of the present invention, as the basis for the claims and as a basis for teaching one skilled in the art on how to make and/or use the invention. However in certain instances, well-known or conventional details are not described in order not to unnecessarily obscure the present invention in detail.

The preferred embodiment of the present invention details an end user privacy protection system and method thereof that enables the user to restrict app/software access to mobile phone hardware such as camera, microphone, and storage, as well as location services such as GPS/GLONASS or similar services by default. If the user needs the applications or software to use any of these hardware components/services, the user needs to interact with the system and choose an approximate required time of connection, whereupon the device's hardware/services will be accessible to the application' based on the privileges granted to that application (app) at the time of its installation.

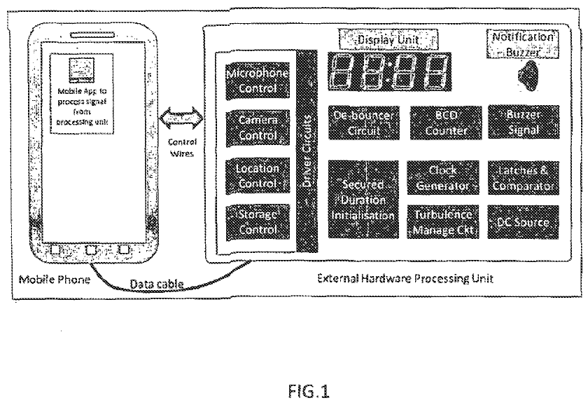

Referring to FIG. 1, the end user privacy protection system features a Hardware Processing Unit (HPU) configured to receive control connections from hardware components such as camera, mic, and storage as well as location services in a mobile phone. In its industrial design, the unit/device is configured to be plugged into a smart mobile phone, tablet/PC or any handheld device through a suitable interface provided. Once the control connections are taken to the HPU, the processing unit will restrict the access to these hardware devices/services in the mobile phone to any app/software installed in said mobile smart phone/PC by default.

Consequently, whenever an app needs to use any of these components, the user has to trigger the HPU device and select the approximate required time of connection. Based on said time frame, and privileges granted to the app at the time of installation, these hardware components/services will be accessible for the apps for the set duration. The remaining time available is also simultaneously shown in the display unit. In addition, a distinct buzzer notification is provided at 19 seconds and 09 seconds respectively before the permitted time expires.

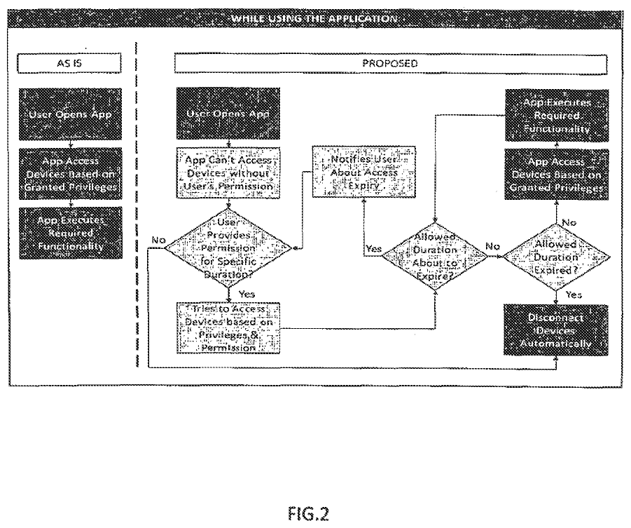

Therefore, the user could extend the once set time duration based on his requirements while using the concerned app. FIG. 1 also depicts the other functional blocks and components that are used for the data and signal processing. FIG. 2 illustrates the schematic diagram of the security method for accessing device hardware components during application usage. In the preferred embodiment, 74193 IC is used for the countdown counter.

Referring to FIG. 1, the permitted time during which the hardware components and GLONASS/GPS may be accessed by app(s) is displayed in the display unit. The time is displayed in the form of a countdown counter showing minutes and seconds. As shown in the figure, a clock pulse generator is the basic unit to run the BCD down counters, wherein it is also used for the buzzer pulses. In the preferred embodiment, 4060 IC is used for the clock circuit as well as for generating buzzer pulses.

The Hardware Processing Unit (HPU) of the end user privacy protection system features two micro-switches, wherein one switch is an enabler switch S1 configured to enable the hardware components as well as set the enabled duration. More specifically, in the first press, said switch enables the connectivity of the selected app to the hardware devices and location service, wherein subsequent switch presses is configured to increase the permitted duration of time from zero to 10 minutes cyclically. Further extension to several minutes and hours is possible, if required. The second micro-switch S2 is a disabler switch configured to disconnect the hardware components at any point in time. Once said disabler switch is pressed, the access to mic, camera, and GPS is stopped and file access to storage space is blocked. On pressing said switch, the mic, camera & GPS will be permanently disconnected from its usage.

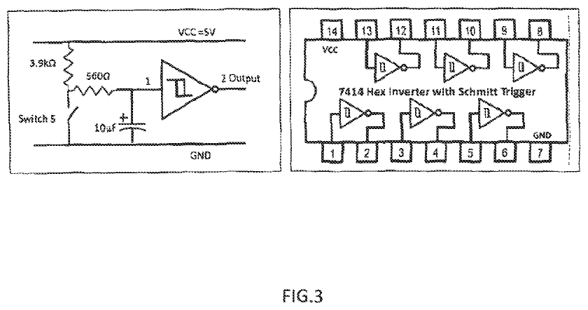

In order to pre-empt the possibility of multiple signals getting generated in a single switch press, a de-bouncer circuit is employed, as shown in FIG. 3. Further, a time setter circuit configured to set time from zero to 10 minutes is provided, wherein it features a counter that is incremented on each pulse (up to 10 minutes) when user clicks on the enabler switch each time to extend the duration. Said counter is then loaded on the running down counter, which is displayed in the display unit. In the present embodiment, 7490 mod 10 BCD decade counter IC is used as the time setter, and IC 74193 as the down counter.

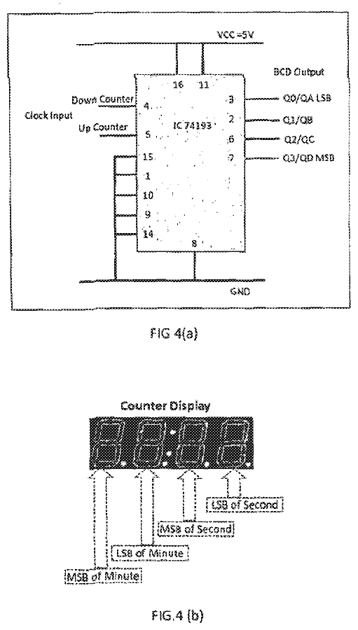

The IC 74193 with the load inputs are shown in FIG. 4(a). In order to run it as down counter, the clock is applied on pin 4. The outputs are taken out from the pins 3, 2, 6 & 7, wherein the pin 3 is the LSB and 7 is the MSB. The 74193 IC is also configured to load a specific input, wherein the up or down counting could be started from a specific value. As shown in the diagram, the load input pins are 9, 10, 1 & 15 from MSB to LSB. A given input data is loaded to the counter when the pre-set pin 11 becomes GND. The MSB and LSB of second display, and LSB of minute display are illustrated in FIG. 4(b).

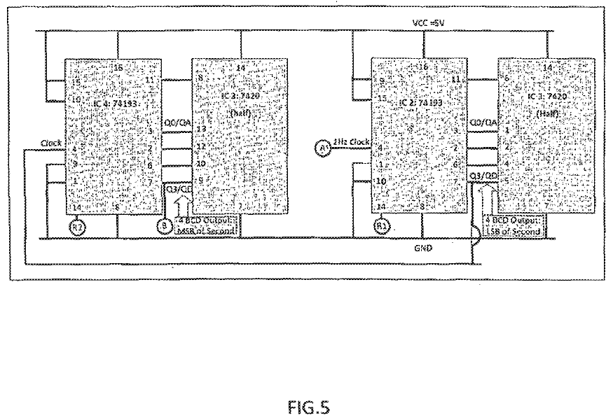

The preferred embodiment of the present invention uses a four digit counter. The circuit for generating the seconds' digits are depicted in FIG. 5. As shown in the figure, the 74193 IC on the right hand side is the down counter configured to run the display's LSB second digit, wherein it runs from 0-9 in BCD. The 1 Hz clock pulse is given at pin 4 (point A) from the IC 4060 clock generator. It will be running from zero to nine in the BCD. This is achieved using the load inputs set to 9 (1001 is the binary corresponding to 9) and the 7420 NAND IC output connected to pre-set pin of 74193. The counter starts at nine and counts down to zero. After zero, the next digit is 15 (1111 is the binary corresponding to 15), which means that all the counter outputs are one, therein causing the NAND IC to output GND signal at the counter pre-set pin 11, whereupon it loads 9 again. The output pins 3, 2, 6 & 7 are the BCD outputs of the display's second digit.

The left hand side 74193 IC is configured to run the display's MSB second digit. The clock pulse for this bit is given from the MSB BCD output of first unit (Q3 of LSB second). It is configured to run from 0 to 5 wherein its working is similar to the LSB of second as explained above except that the loading values is changed to 5 (0101 is the binary corresponding to 5). Half part of the NAND gate IC is used for the first digit and remaining half for the next digit.

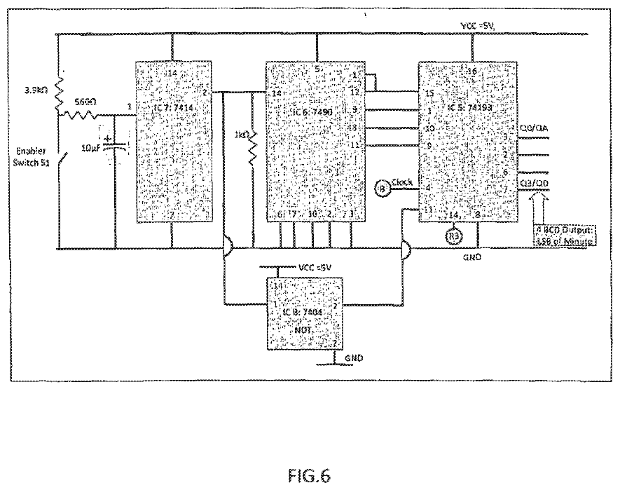

FIG. 6 illustrates the circuit for generating the MSB and LSB of minute. As shown in the figure, the 79493 IC is configured to generate the LSB of minute digit. There are two stages ahead of the counter IC, wherein the first block is a de-bouncer circuit with a switch and 7414 IC. As mentioned, pressing the ENABLER switch S1 allows app access to mobile hardware components such as camera, mic and location services. Said switch pulse is de-bounced by the 7414 Schmitt IC to eliminate any chance of multiple signals being generated during single switch press.

The enabler switch S1 has two functionalities. As mentioned, activating said switch allows app' access to the mobile phone hardware components, and the second functionality is to manually set the duration for which access is allowed by the system. That is, in the first press, it enables the access to the hardware components, wherein the subsequent switch presses cause to increment the allowed time duration from zero to 10 minutes cyclically.

The output of the 7414 de-bouncer output is fed to the 7490 counter, wherein upon each switch press, the counter is incremented by one (+1) wherein it is fed to the load pins of the 74193 counter. The pre-set pin of the 74193 counter is fed from the 7404 IC. That is, the load input pins are loaded during the switch press, wherein it is immediately preceded by loading the pre-set pin. As shown in the figure, the clock pulse for the 74193 IC is provided from the previous stage. So the counter will be running as usual. It is loaded from the enabler switch (between 0 and 10 minutes).

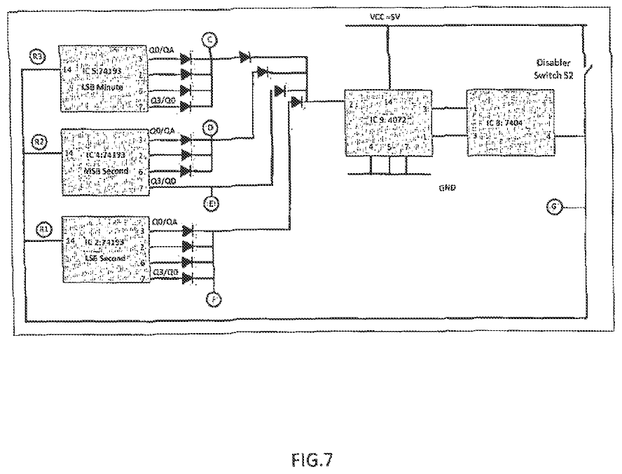

As depicted in FIG. 7, the system features a comparator unit configured to disable an application's access to the camera, mic, GPS and storage unit once the countdown reaches 00.00 minutes. As shown in the figure, the comparator compares the output using the diodes and 4072 OR gate IC. Output of this signal is applied to the reset pin of 74193 ICs of count-down counter and also given to the driver circuit to disconnect the hardware, location services and storage access.

Specifically, as illustrated in FIG. 7, the BCD outputs are OR-ed using the diodes and is given as one input of the 4072 OR gate IC and another input of OR gate is given as the inverted de-bouncer output. The output of the OR gate is given to a second NOT gate (7404 IC, pin 3 is input and 4 is output) wherein said NOT gate's output is connected to the reset pin of the 74193 counter ICs. Hence, the counter resets when the counter or display becomes 00:00. The output is illustrated as G in FIG. 7, which is fed to the driver circuit of camera, mic, GPS and secured file access through a relay/opto-coupler driver circuit. Further, the outputs C, D, E & F are left for the buzzer with a distinct pacing sound at 00:19 seconds and 00:09 seconds.

As per the preferred embodiment of the present invention, the user could start another session, when the counter is stopped and the display reads 00:00. To begin said session, the enabler switch is pressed to generate a pulse wherein it is fed to the 4072 OR gate IC through a 7414 de-bouncer IC and 7404 NOT gate IC (first NOT gate), as depicted in FIG. 6. As a result, the output of the OR gate IC will go HIGH wherein it is connected to the reset pin of 74193 down counter IC through a second NOT gate (as shown in FIG. 7) to start and run. As shown in the figure, the output of the enabler switch is connected to the time setter 7490 IC through the same de-bouncer circuit. As a result, with each enabler switch press, the time setter 7490 MOD 10 counter IC is incremented from 0 to 10 cyclically.

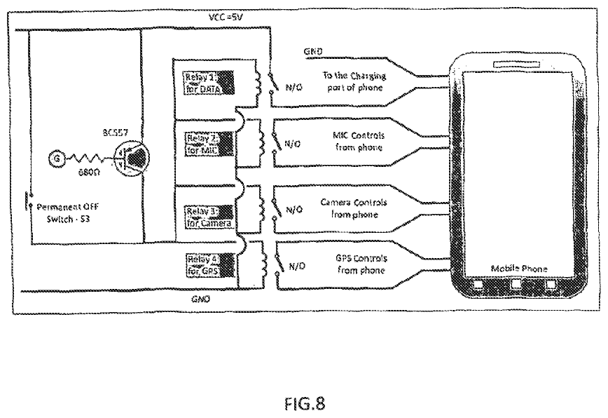

The driver circuit is depicted in FIG. 8. Whenever the counter is running, the OR-ed diode's output will be HIGH and subsequently the second NOT gate's output goes LOW. This LOW output is connected to the PNP transistor therein turning it ON, which in turn activates the relay, causing the mic, camera, GPS and storage to be accessible for the apps. When the counter counts down to 00:00, the OR output goes LOW and subsequently the relay disconnects said hardware components. The driver circuit is realized using relays or electric/electronic switches.

In another embodiment of the present invention, the app's access to the hardware components such as camera, mic and storage as well as location services may be regulated independently as per user requirement. That is, the app's access to one or more of the hardware components may be individually selected and blocked without restricting access to the other components.

As shown in FIG. 8, a PERMANENT OFF switch S3 is provided to exclude all the circuits and logic. When this switch is turned ON, all the hardware components such as camera, microphone, and storage as well as location services will be connected permanently, similar to current manual operation and there will not be any disconnection of the mic, camera, GPS & secured file copy based on the user input.

The system also features a paced buzzer notification module to provide two distinct voice notifications to the user when the allotted time counts down to 00:19 second and 00:09 second respectively. For example, if the user is speaking over a call, he might not notice the time left on the counter or if it is about to expire, and as a result, his call might be disturbed by the mic disconnection. Therefore, to avoid such a situation, the buzzer is configured to provide beep alarms from 00:19 second with less noise (0.5 Hz) and with high pace noise (0.25 Hz) notification at 00:09 second onwards.

Circuits to eliminate harmonics, and a circuitry to reset the counter to start from zero every time is also included.

### Testing

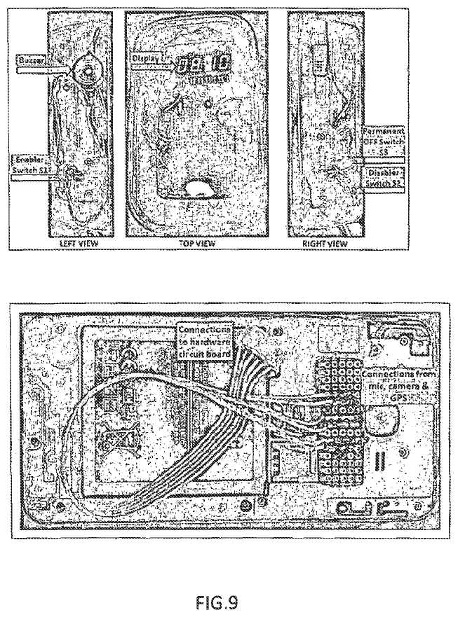

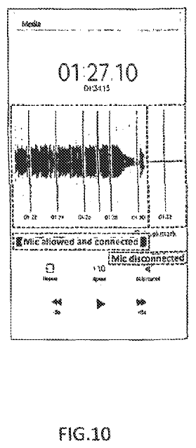

The Hardware Processing Unit (HPU) of the end user privacy protection system integrated to a mobile phone is shown in FIG. 9. As shown in the figure, an android mobile phone unit is employed, wherein the connections of its microphone, camera and GPS (devices) are extended outside wherein it is connected to the hardware-processing unit. FIG. 10 depicts the screenshot of the recorded voice, where the voice is shown in the visual representation of waves.

The red section illustrates the duration wherein the mic is allowed for recording, wherein the up and down voice waveform indicates that the recording was in progress. When the allowed time count downs to zero or, by pressing the disabler switch, the permission to the mic is revoked wherein said mic is removed from the operation. The green section shows the sound profile when the mic is revoked. In said system, as the control wires are taken out wherein they are physically disconnected through a hardware switch, it is impossible to restore the mic connection through software means or program. The access to mic is controlled/restricted for, but not limited to, incoming calls, outgoing calls, voice recorder, and social media platforms.

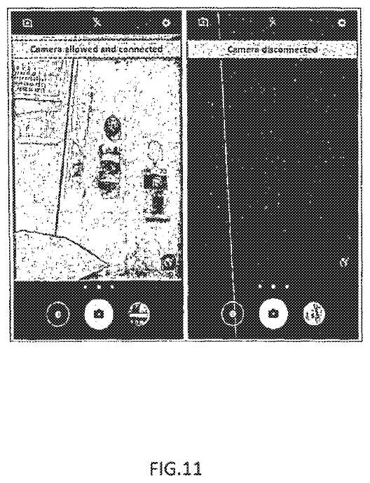

Similarly, the camera access is controlled, as illustrated in FIG. 11. Using the current system, the access to camera is controlled/restricted for, but not limited to, incoming calls, outgoing calls, video calls, and social media platforms. When the disabler switch is pressed or the available duration has been expired, the camera is removed from operation and any app or software will not be able to tap image or video from the camera at all. As the control wires are taken out wherein they are physically disconnected through a hardware switch, it is impossible to restore the camera connection through software or program.

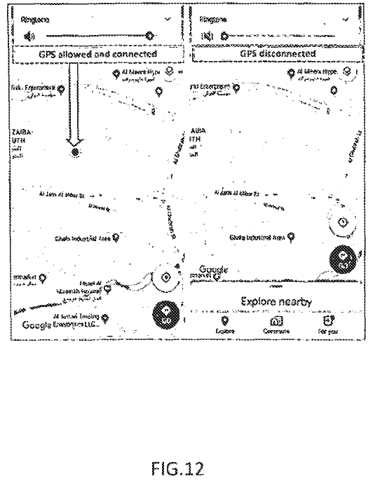

The HPU is also configured to connect and disconnect the GPS whenever the user allows or revokes the permission. The instances wherein the GPS was accessible, and when the access was restricted, are illustrated in FIG. 12. The end user privacy protection system also features a log register to log all the mic, camera, GPS and file access operations.

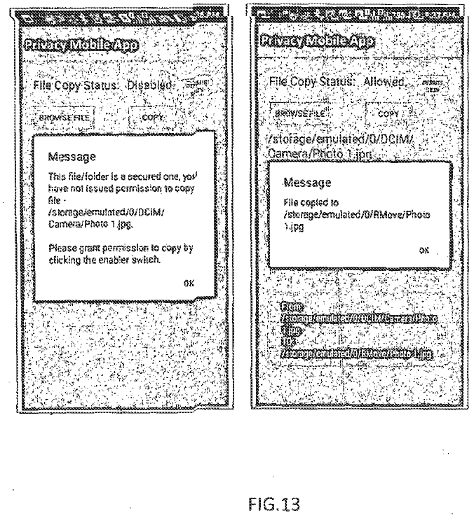

In order to demonstrate file access and copy with user permission and control, a privacy mobile app is used. The files or folders to be secured are stored in a configuration file. The privacy mobile app is configured to check whether the file path exists in the configuration file. If the file path or containing folder is present in the configuration file, the user permission is required to access and copy the corresponding file. The user permission is fed from the Hardware Processing Unit to the mobile app via the charging USB port of the mobile device. If the user does not give permission, then the file access and copy is not allowed. Once the user grants permission, the file access and copy is allowed to the app. If the file path is not available in the configuration file, then these restrictions does not exist and these files are freely accessed and copied as existing. FIG. 13 shows the file copy/access in conditions wherein the file copy and access permission was denied, and allowed respectively.

The present invention can be implemented not only to the mobile devices or computer, it can be extended to units such as tablets, smart devices, wearable devices wherever the microphone, camera, GPS or similar service, data storage operation is present.

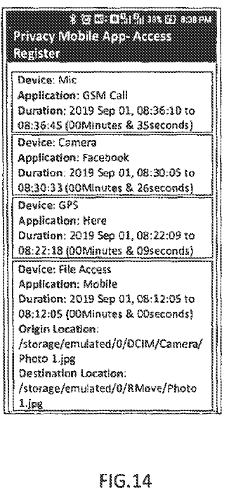

As depicted in FIG. 14, an access register could be implemented to track and display the history of accesses made by apps to the mobile phone mic, camera, GPS and data storage. It enables the user to search and identify if there is any unauthorised accesses or hacking attempts done in his devices using this register.

Although the present invention has been described in connection with the preferred embodiments thereof with reference to the accompanying drawings, it is to be noted that various changes and modifications are possible and are apparent to those skilled in the art. Such changes and modifications are to be understood as included within the scope of the present invention unless they depart there from.

I claim:

1. An end user privacy protection system that enables users to restrict application' access to mobile hardware components such as camera, microphone, and storage as well as location services, except for user decided duration, said system comprising of:
a hardware interface adapted to receive control connections from said mobile hardware components;
time setter unit configured to set time from zero to 10 minutes, wherein a counter is incremented on each incremental pulse generated by pressing an enabler switch (S1) by the user;
run down counter configured to be loaded from said counter, wherein said run down counter is activated by the enabler switch (S1) press;
comparator unit configured to disable application's access to the camera, mic, GPS, storage as well as location services once the countdown on the run down counter reads 00.00 minutes;
electric/electronic switches or relays configured to connect and disconnect access to the respective mobile phone hardware components; and
driver circuit configured to operate said electric/electronic switches or relays, wherein said driver circuit is driven by the output of the comparator unit.

2. The end user privacy protection system as claimed in claim 1, wherein the comparator circuit is configured to activate or deactivate the run down counter.

3. The end user privacy protection system as claimed in claim 1, wherein the run down counter is configured to be reset to a new time on pressing enabler switch S1 even if a present countdown is in progress.

4. The end user privacy protection system as claimed in claim 1, wherein the driver circuit features a permanent off switch (S3) to facilitate application's permanent access to the mobile phone hardware.

5. The end user privacy protection system as claimed in claim 1, wherein the enabler switch (S1) output is fed to a de-bouncer circuit.

6. The end user privacy protection system as claimed in claim 1, wherein the comparator unit features a disabler switch (S2) configured to physically disconnect access to the mic, camera, GPS and file access (storage) at any time by user's interest.

7. A method to regulate application access to mobile phone hardware components such as camera, microphone, and storage, as well as location services for user selected duration, said method comprising of:
setting the time on the timer by pressing the enabler switch (Si), during when the application' access to said hardware components is allowed, wherein the associated counter is incremented on each incremental pulse generated by respective switch presses;
loading said time dynamically on the run down counter;
checking the down counter by the comparator unit, wherein it maintains a first digital logic state when the counter is set to a value and when it is down counting;
activating the electric/electronic switches/relays to connect the mobile phone hardware controls by the driver circuit based on said first digital logic state;
generating a second digital logic state by the comparator unit when the countdown reaches a pre-determined number; and
deactivating the electric/electronic switches or relays to disconnect the respective mobile phone hardware components by the driver circuit.

8. The method as claimed in claim 7, wherein the electric/electronic switches or relays disconnect the respective mobile phone hardware components based on the second digital logic state.

9. The method as claimed in claim 7, wherein the access to the files and folders having their file path saved in a configuration file is restricted.

10. The method as claimed in claim 7, wherein the access restriction method works irrespective of type of operating system in the mobile phone, computer, laptop, wearable devices and similar smart devices.

11. The method as claimed in claim 7, wherein the pre-determined number is 00:00.
